(19) United States
(12) Patent Application Publication
(10) Pub. No.: US 2017/0206107 A1
(43) Pub. Date: Jul. 20, 2017

(54) Systems And Methods For Provisioning Of Storage For Virtualized Applications

(71) Applicant: Aloke Guha, Louisville, CO (US)

(72) Inventor: Aloke Guha, Louisville, CO (US)

(21) Appl. No.: 15/479,042

(22) Filed: Apr. 4, 2017

Related U.S. Application Data
(63) Continuation-in-part of application No. 13/767,829, filed on Feb. 14, 2013.
(60) Provisional application No. 61/598,803, filed on Feb. 14, 2012.
(60) Provisional application No. 61/732,838, filed on Dec. 3, 2012.

(51) Int. Cl. G06F 9/455; H04L 12/24

(52) U.S. Cl. CPC G06F 9/45558; H04L 41/5009; G06F 2009/45595; G06F 2009/45583; G06F 2009/45591; G06F 2009/4557

(57) ABSTRACT

Methods for provisioning storage for virtual machines by meeting a service level agreement (SLA) are disclosed. The SLA pertains to the operation of a virtual machine. An example of the method includes monitoring the workload of the first virtual machine; establishing at least one service level objective (SLO) in response to the observed workload; determining an SLA that meets the at least one SLO, wherein the SLA defines the time the SLO is satisfied; and provisioning at least one resource used by the first virtual machine in response to the SLA not being satisfied, wherein the provisioning causes the SLA to be satisfied.

This application is a continuation in part of U.S. patent application Ser. No. 13/767,829, filed on Feb. 14, 2013, which claims priority to U.S. Provisional Patent Application 61/598,803 titled “OPTIMIZING APPLICATION PERFORMANCE ON SHARED INFRASTRUCTURE USING SLAs” filed on Feb. 14, 2012 and U.S. Provisional Patent Application 61/732,838 “SYSTEM AND METHOD FOR SLA-BASED DYNAMIC PROVISIONING ON SHARED STORAGE” filed on Dec. 3, 2012, which are both hereby incorporated by reference for all that is disclosed therein.

### BACKGROUND

A common approach for managing the quality of service for applications running in computer network systems is to specify a service level agreement (SLA) on the services provided to the application and then meeting the SLA. The computer systems include physical computers and virtual computers or machines. A task related to applications is provisioning or allocating the appropriate storage per the SLA requirements over the lifecycle of the application. The problem of provisioning the correct storage is most significant in virtualized data centers where new instances of applications running in virtual machines on the physical computer are added or removed on an ongoing basis.

To ensure SLA-managed storage for the applications running in the virtual machines, it would be desired to provision storage for the application at the virtual machine-level for each virtual machine. There are a number of challenges in provisioning of virtual machines on shared storage. First, a target logical storage volume provisioned to a virtual machine can be at different physical locations relative to the virtual machine. It could be local to the virtual machine host server or a hypervisor host computer located behind a network. In some examples, the target storage volume is remote across a wide area network. Second, the storage requirements for the virtual machine as specified in the SLA can include many different attributes such as performance, capacity, availability, etc., that are variable and not known a priori. Third, the performance aspects of a logical storage volume within a physical storage system are difficult to estimate.

One common approach to provisioning virtual machine storage is over-provisioning, i.e., over allocate resources needed to satisfy the needs of the virtual machine, even if the actual requirements are much lower than the capabilities of the physical storage system. The primary reason for over-provisioning is that the user of the application running in the virtual machine does not have prior knowledge or visibility to the application workload requirements or the observed performance, so to reduce the possibility of failure, over-provisioning of the storage resources has become the de facto approach. Another approach taken by some virtual machine managers or management software is to monitor the virtual machine logical storage service levels, such as latency, bandwidth, etc., In the event that the storage system cannot meet the SLA, the virtual machine manager migrates the logical storage volume to an alternate physical storage system.

Unfortunately, reactively migrating virtual machine logical storage volumes can result in performance problems. For example, the new storage system to which the logical storage of the virtual machine has been migrated may not be the best choice. This is a limitation of the virtual machine storage manager enforcing the SLAs for virtual machines since it may not have visibility into the detailed performance capabilities of the storage system. However, the storage system that contains the virtual machine logical storage volume does not always have knowledge of the requirements of the application in the virtual machine. The combination of the limitations that the virtual machine manager and the storage systems face increases the difficulty of dynamically provisioning virtual machine storage in virtualized data centers.

### SUMMARY

Methods for provisioning storage for virtual machines by meeting a service level agreement (SLA) are disclosed. The SLA pertains to the operation of a virtual machine. An example of the method includes monitoring the workload of the first virtual machine; establishing at least one service level objective (SLO) in response to the observed workload; determining an SLA that meets the at least one SLO, wherein the SLA defines the time the SLO is satisfied; and provisioning at least one resource used by the first virtual machine in response to the SLA not being satisfied, wherein the provisioning causes the SLA to be satisfied.

### BRIEF DESCRIPTION OF THE DRAWINGS

FIG. 1 is a block diagram illustrating an example of a plurality of virtual machines (VMs) coupled to a plurality of logical storage volumes (LSVs) that are co-located in a shared data storage system (SDS).

FIG. 2 is a block diagram illustrating example locations of the SDS of FIG. 1.

FIG. 3 is a flowchart depicting an embodiment for enforcing service level agreements (SLAs) of virtual machines using shared data storage.

FIG. 4 is an example of an implementation of SLA monitoring and enforcement performed in a host server.

FIG. 5 is a graph showing a lower priority virtual machine increasing its workflow, which causes other virtual machines to fail to meet their SLAs.

FIG. 6 is a graph showing how closed loop control in a network improves SLA adherence for a virtual machine to acceptable levels when the SLA is enforced on all workloads.

FIG. 7 is a is a graph showing a method for estimating available or residual storage performance capacity, which may be in terms of estimating a combination of available bandwidth and I/O throughput.

FIG. 8 is a diagram showing I/O merging in a shared data storage queue to enforce different service levels of the virtual machines of FIG. 1.

FIG. 9 is a diagram showing an example of I/O scheduling in a shared storage queue as illustrated in FIG. 8.

FIG. 10 is a graph showing an example of latency versus I/O throughput of two virtual machines in normal operation.

FIG. 11 is two graphs showing an example of SLA enforcement in a host server to enforce SLAs on a lower priority virtual machine relative to the situation of FIG. 10.

FIG. 12 is a flow chart describing an example method for dynamic provisioning storage.

### DETAILED DESCRIPTION

Embodiments of virtual machine-level storage provisioning are disclosed herein. The embodiments include virtual machine-level logical storage volumes (LSVs) that present a granular abstraction of the storage provisioning. The embodiments enable creation and management of virtual machine-level storage objects regardless of the network that provides the connectivity from virtual machines to a shared data storage system (SDS). The problems addressed herein and the solutions presented apply to both traditional virtualization where a virtual machine is an emulation of a physical computer that executes programs as a physical or real computer would, as well as to software containers such as Linux containers, that provide operating-system-level virtualization by abstracting a “user space.”

Several terms and metrics used herein are defined as below. An SDS contains at least one LSV and refers to the unit of shared disk or storage resources. I/O size refers to the size of an input/output (I/O) packet. Read/write typically identifies small computer systems interface (SCSI) commands, whether read, write, or other non-read or non-write commands. Service time or latency of response to an I/O is the completion time of an I/O by the SDS. I/O submission rate is the number of I/O submitted over a multiple of an intrinsic measurement interval (tau) of the application and for every measurement interval related to the application, such as six-second intervals. I/O completion rate is the number of I/O completed per a measurement interval. Cache hit is a Boolean value indicating whether an I/O was served from cache or from a disk and is based on an observed value of latency for an I/O command. Periodic estimates for an I/O input rate or the I/O completion rate and derived metrics are performed after I/O input or latency information has been obtained. For example, the estimates do not have to be performed in a kernel, but rather, they may be calculated in a batch mode from stored data in a database. The aforementioned terms also apply to estimating in the short term, such as over small periods that may be less than the measurement intervals described above as well as every measurement interval of an I/O submission rate or an I/O completion time.

VM-level logical storage is the LSV within a SDS that is allocated to each virtual machine. LSV is typically a logical unit of storage within an SDS. An example of an LSV is a logical unit number (LUN) that can address storage protocols such as SCSI commands. An LSV can also be a storage object that can be addressed via a custom application programming interface.

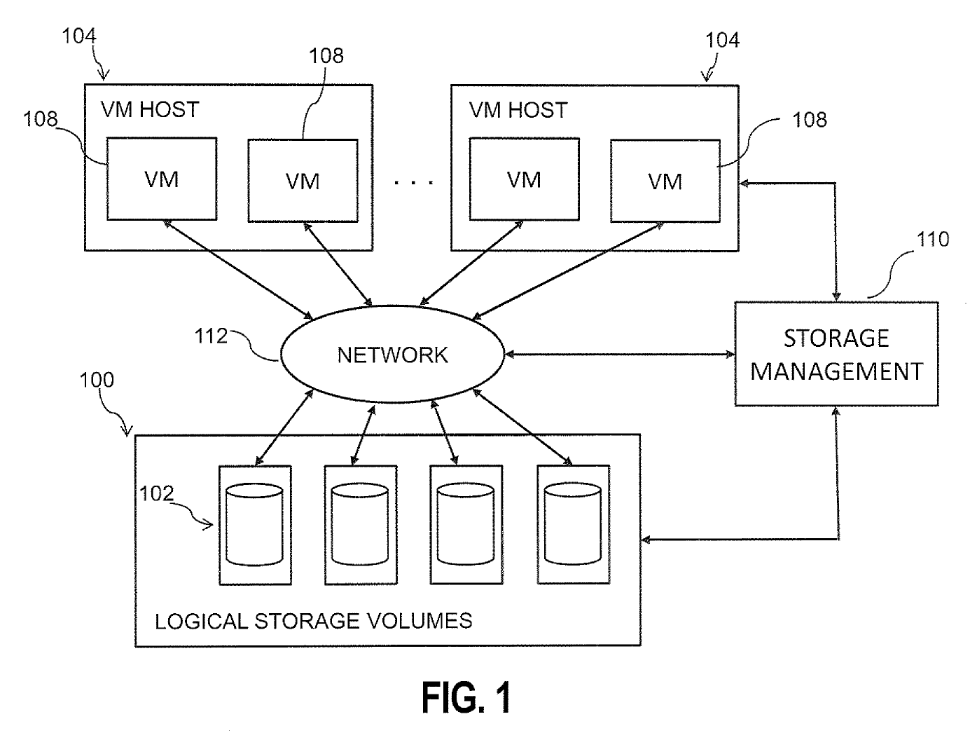

FIG. 1 is a block diagram of an example of an SDS 100 with components coupled thereto. The SDS 100 includes a plurality of LSVs 102 that are accessible by a plurality of virtual machines 108 located in at least one VM host 104 through a network 112. In some embodiments, the VM hosts 104 are located in a data center or the like. The virtual machines 108 are associated with VM hosts 104 that may implement virtual machine management systems or hypervisor servers (not shown). Hypervisors are not required in the case of operating system virtualization such as containers. In the case of operating system virtualization, virtual entities or software containers are directly resident on the host computer. The mapping of all VM hosts 104 in a data center or the like includes all virtual machines 108 on all hypervisors and all LSVs 102 on all SDSs 100. The network 112 may embody many different types of networks including a Fibre Channel storage area network, an internet small computer system interface (iSCSI) network, and an internet protocol (IP) based Ethernet local area network (LAN). The SDS 100 may be implemented in many different embodiments including as block storage in a hard disk array or as a file system that uses a hard disk array as its backend storage.

Each VM host 104 is associated with at least one virtual machine 108 and each VM host 104 has a storage requirement associated therewith. The storage requirements of the virtual machines 108 may be expressed in the form of a storage template and are sometimes referred to as service level objectives (SLOs) that specify specific performance requirements. Examples of specific performance requirements include bandwidth (data rate such as megabytes per second), throughput (I/O operations per second), which may be the I/O completion rate, and latency for read or write commands. The storage requirements of the virtual machines 108 in VM host 104 can be met by choosing or linking to at least one of the LSVs 102 in the SDS 100 by means of the network 112. The virtual machines 108 can express the requirements of their associated LSVs 102 in such attributes as availability, performance, capacity, etc. These requirements can then be sent to a storage management 110 that coordinates with the SDS 100 to determine which LSV 102 is the optimal choice to meet the requirements. A storage provisioning system that is embodied in the storage management 110 can discover LSVs 102 on a multiplicity of SDSs 100 that currently meet the SLOs of the storage requirements for each of the virtual machines 108.

The use of the LSVs 102 creates a VM-level granular storage abstraction. Such VM-level storage abstraction decouples the location of storage for a virtual machine 108 from the physical location on a SDS 100 while providing the granular flexibility of either or both. A first method for accomplishing the decoupling includes assigning the storage for the virtual machine 108 to a different LSV 102 on a different SDS 100 if the SLOs related to the storage of the virtual machine 108 cannot be met by a LSV 102 on the current SDS 100. A second method for decoupling includes modifying or “morphing” the current LSV 102 by changing the resource allocation to another LSV 102 on the same SDS 100 when it is possible to meet the SLOs within the same SDS 100. Such an approach enables more proactive control for the storage system to modify the current storage of the virtual machine 108 or select the best target location for the storage for the virtual machine 108. By using either of the two above-described methods, a dynamic storage provisioning system can be implemented that continually adapts the provisioned LSVs to enforce application SLAs by meeting specific SLOs in performance, availability, compression, security, etc.

A virtual machine 108 may include of one or more flows depending on whether distinct flows are created by the virtual machine. For example, metadata or index data may be written to an LSV on a fast SDS while the data for the virtual machine 108 may be written to an LSV on a slower SDS. In some examples, a single virtual machine 108 may include a group of flows. In such a case, as in backup application scenarios, a backup application will include a multiplicity of flows from a virtual machine 108 to an SDS that is designated for streaming backups.

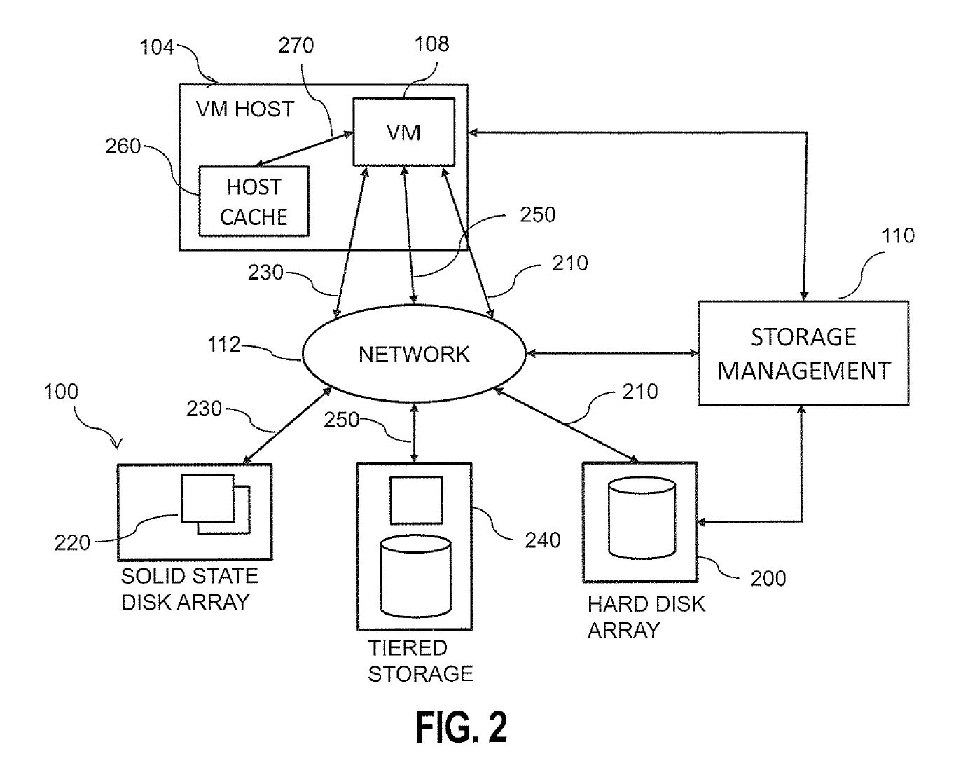

FIG. 2 is a diagram showing different locations for the SDS 100 of FIG. 1. The SDS 100 can be located in a plurality of locations, such as in a data center as shown in FIG. 2. A first embodiment of the location of the SDS 100 is in a hard disk array 200 coupled to the network 112, wherein a virtual machine 108 couples to the hard disk array 200 via a network path 210. A second embodiment of the location of the SDS 100 is in a solid state disk or solid state disk array 220 that connects to the virtual machine 108 via a network path 230. A third embodiment of the location of the SDS 100 is in a tiered storage system 240 that may combine a solid state disk and/or a hard disk array that connects to the virtual machine 108 via a network path 250. A fourth embodiment of the location of the SDS 100 is in a local host cache 260, which is may be a flash memory card or a locally attached solid state disk in the VM host 104 and connects to the virtual machine 108 via an internal network connection or bus connection 270. In another embodiment, the SDS 100 may be located in a host computer system (not shown) that contains a hypervisor and virtual machine manager and thus, the virtual machine 108.

Based on the foregoing description of FIG. 2, there are many choices available for a virtual machine 108 to meet its specific storage SLOs by connecting to SDSs 100 in different locations. By connecting with different SDSs 100, the virtual machine 108 is connecting with the different LSVs associated with the SDSs 100. If the performance in terms of latency is the highest priority, then provisioning the SDS in the host cache 260 is a likely provisioning option. If read and write operations with low latency and larger storage space is a consideration, then provisioning the SDS on the solid state disk array 220 to be accessible by the network 112 is a better option. For example, the solid state disk array 220 can typically accommodate a large number of drives and therefore more storage capacity is available to the virtual machine 108. If an intermediate performance is required, then the tiered storage system 240 that uses solid state drives as a cache and hard disk arrays as a secondary tiered storage is a good option for the SDS 100. If the latency needs are not as stringent, the SDS 100 may be provisioned on the hard disk array 200.

The examples described above show multiple options for provisioning of the SDS 100 and its associated LSV 102 for a virtual machine 108. The criteria for provisioning the storage for the virtual machine 108 is dictated by the service level objectives (SLOs) for virtual machine storage and the attributes of the available SDS 100 shown in FIG. 1 and the alternatives shown in FIG. 2. The provisioning process of selecting the most appropriate SDS 100 for a virtual machine 108 is performed on a continuous basis since new virtual machines 108 may be added within the VM host 108, which changes the total demand for storage and storage performance in the SDSs 100. Furthermore, the pool of available LSVs 102 associated with the SDSs 100 changes over time as storage is consumed by the existing operating virtual machines 108 on their LSVs 102 across all SDSs 100. New SDSs 100 are added, and/or space for allocating LSVs 102 increases when an existing virtual machine 108 is deleted or decommissioned.

The basis for determining whether the requirements for operating a virtual machine 108 can be satisfied by an LSV 102 is determined by the service level objectives (SLOs) requirements of the virtual machine 108. These requirements typically include specifications, limits or thresholds on performance, availability, compression, security, etc. An example of a performance SLO is latency being less than a predetermined time, such as less than 1 ms. An SLO based on availability may include recovery time objective (RTO) or the time required to recover from a data loss event and the time required to return to service. For example, an SLO may require that the RTO be less than thirty seconds. A virtual machine 108 may specify multiple SLOs that include the desired objectives of performance, data protection, availability, etc. Dynamic provisioning therefore ensures that all SLOs of the virtual machine 108 can be met by the selected SDS 100 assigned to the virtual machine 108 as new VMs are added or removed or as an SDS performance capacity changes. If a currently provisioned SDS 100, or its associated LSV 102, cannot meet the specified SLOs for virtual machine 108, then a new mapping is required. The new mapping assigns the virtual machine a new SDS 100 or a new LSV 102 that can meet the specified SLOs.

Based on the foregoing, the process for provisioning storage for virtual machines 108 may be performed as follows. A virtual machine 108 needs to specify at least one SLO. SDSs 100 and their LSVs 102 are identified and access points, or the protocol endpoints (PEs), required by the virtual machines to connect to the LSVs 102 are identified. The SLO attributes of the LSVs 102 that are available for provisioning are continuously updated as more virtual machines 108 are provisioned on the SDS 100 which the LSV 102 is located and the available performance capacity is reduced. Thus, provisioning is the assignment of the best fit LSV 102 to the virtual machine 108 based on its storage profile.

An example of an approach for enforcing an SLA on an LSV 102, FIG. 1, when the LSVs 102 are co-located on SDSs 100 is described below. The approaches described herein represent a close-loop control system for enforcing SLAs on virtual machines that share storage.

Methods for solving the virtual machine to shared storage performance enforcement problem are described herein. In the following description, a virtual machine to virtual storage connection is sometimes referred to as a nexus of virtual machine-to-logical storage volume or simply as an I/O flow since it represents the flow of I/O read or write data from the virtual machine to its assigned virtual storage. Thus, flow refers to the combination of the virtual machine and its associated assigned LSV (VM 108-LSV 102) tuple. The flow may also refer to a similar combination of the source of the I/O and the target storage element on an LSV 102 or logical unit number (LUN) that uniquely defines the flow or I/O path from an initiator in the virtual machine 108 to the target LSV 102.

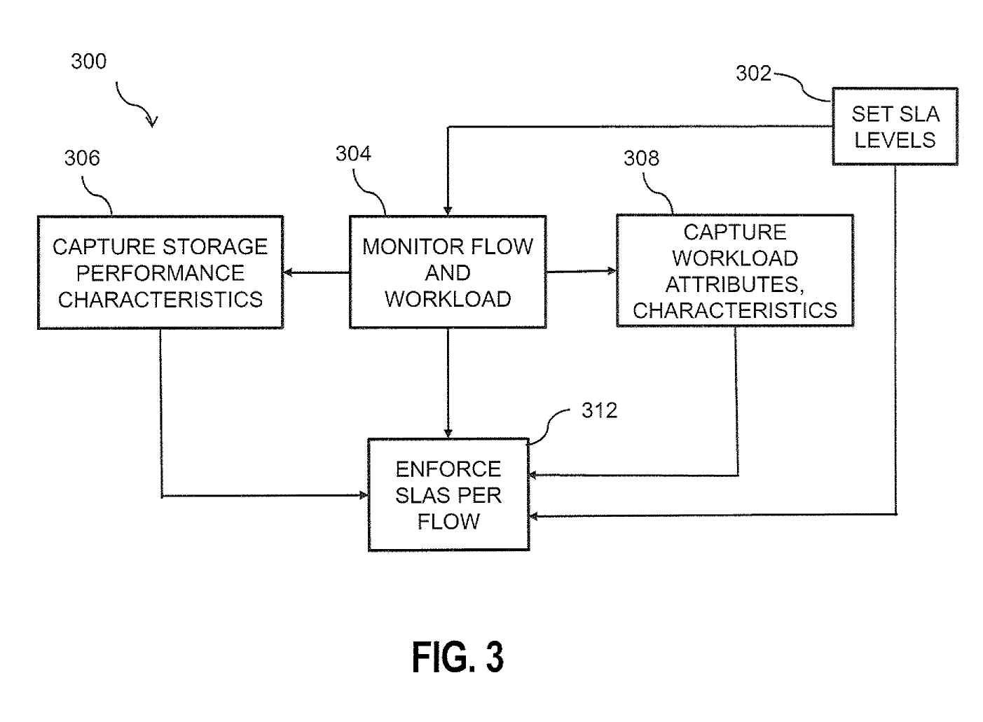

Additional reference is made to FIG. 3, which is a flowchart 300 depicting an example of a method for enforcing the SLA related to the performance SLO of a virtual machine using an SDS. It is noted that the modules performed in the flow chart 300 may be performed by the storage management 110, FIG. 1. The first module of the flow chart 300 is module 302 where SLAs and service levels (described below) are specified. SLAs are assigned by a user to each virtual machine 108, FIG. 1. In the examples described herein, each flow is assigned an SLA and an associated service level, such as platinum, gold, silver, etc. The service levels are sometimes referred to as first, second, and third service levels, wherein a service level specifies the level of performance, e.g., a statistical guarantee where a minimum percentage of I/Os in the flow are guaranteed to meet specified SLOs over a prescribed monitoring time period. In addition, a user may also specify whether the underlying I/O workload is latency sensitive, bandwidth, sensitive, data rate-sensitive, or mixed latency and bandwidth sensitive.

In module 304 of the flow chart 300, a flow is monitored to capture its associated workload attributes and characteristics and implicit performance needs for the virtual machine that generates the workload. After the SLAs have been assigned in module 302, the virtual machines are run and information is collected on the nature of the workload by flow and the performance each virtual machine is experiencing. While flows are monitored on a continuous basis, during an initial period, information may be collected on the static and dynamic attributes of each workload. Static attributes include information such as I/O size, sequential versus random access, etc. Dynamic attributes include information on the rate of I/Os, burst size, etc., over an intrinsic time period of the workload. The period of initial monitoring is kept large enough to capture typical temporal variability that is to be expected. For example, initial monitoring may be one to two weeks, but even much shorter time frames can be chosen as a design choice. Based on the policy of the user in how new applications are deployed into production, different virtual machines may be monitored over different periods of time when they run in physical isolation on the SDS 100, FIG. 1. For example, monitoring is performed without any, or negligible, contention with other virtual machines 108 that share the SDS 100 or are provisioned on LSVs 102 on the same SDS 100.

Storage performance characteristics are captured in module 306 and workload attributes and characteristics are captured in module 308. In addition to collecting information related to the workload for each flow, information is also gathered on a continuous basis of the performance of the SDS 100 that hosts the virtual storage for different virtual machines 108 at module 306. As stated above, workload attributes are captured at module 308, which may include I/O failures and/or total memory usage. The goal of the capturing is to determine the total performance capacity of the SDS 100 across the flows that share it. Therefore, fine-grained performance data of I/O levels based on I/O attributes such as the I/O submission rate, I/O completion rate, etc. may be collected.

Module 312 enforces the SLAs per flow. For example, module 312 may guarantee that the SLOs specified by a virtual machine 108 for its LSV 102 are met. This is possible because the needs of the workload of the flows associated with the virtual machine 108 were determined in module 304, as well as the storage performance characteristics of the LSV in module 306. Because the SLA specified earlier defines the required level of performance guarantee, e.g., ensure SLOs are met over a certain percentage of monitoring period, after initial monitoring is complete, module 312 can apply a number of control techniques to enforce the SLAs on the group of flows associated with a virtual machine 108 on a per flow basis. These techniques include admission control using rate shaping on each flow where rate shaping is determined by implicit performance needs of each virtual machine 108 on the SDS 100 and the SLA assigned to the flow. Enforcing SLAs by guaranteeing that SLOs are met for a flow means that resources related to storage or any part of the flow is not shared with fairness across virtual machines 108. The only consideration is meeting SLOs and thus ensuring the resources are provided for each flow. The resources needed to satisfy the SLOs are determined in modules 302 through 308 when the workloads from the virtual machine and the storage performance of the flow are characterized, i.e., the workload fingerprint is captured and the required resources are determined. This approach towards meeting SLAs is therefore not work-conserving in which resources would be shared across multiple virtual machines flows to ensure fairness and make a best effort to meet all SLAs but not guarantee them. Instead, the approach presented is to determine the workload needs of the flows associated with a virtual machine and then per SLAs, determines resources needed to guarantee satisfying the SLAs for that virtual machine.

SLA enforcement at module 312 may also be achieved by deadline-based scheduling that ensures that latency-sensitive I/Os meet their deadlines while meeting the SLO assigned to the flow. This enforcement approach represents a finer-grain level of control beyond the rate shaping approach. Another enforcement approach is closed loop control at the virtual machine 108 based on observed performance at the application level as opposed to the storage or storage network level. The steps for the overall approach of SLA enforcement from a virtual machine 108 to the SDS 100 may include: defining SLAs; characterizing application I/O workloads; building workload templates for common applications; estimating performance capacity of shared storage; enforcing SLAs of virtual machines; planning performance of virtual machines on shared data storage; and dynamic provisioning of LSVs for virtual machines.

In some embodiments, the monitor flow and workload module 304, FIG. 3, derives a fingerprint of the virtual machine I/O requirements over intervals of time, such as milliseconds, seconds, hours, days, and weeks. The fingerprint is a characterization of the workload during tracing. The fingerprint is intended to represent the I/O requirements of the virtual machine, so the fingerprint may need to be re-calculated when virtual machine behavior changes over time. The monitor flow and workload module 304 isolates I/O requests from the virtual machine to the SDS 100, monitors its characteristics, and stores the resulting fingerprint. In some embodiments, the workload fingerprint includes the I/O type (read, write, other), the I/O size, the I/O pattern (random or sequential), the frequency distribution of throughput, and the frequency distribution of latency. Analytic modules 306 and 308 then calculate derived values from these measured values that can be used as inputs to an enforcement software program in module 312 that will schedule I/O requests to the SDS 100 in order to meet the SLO requirements.

In the present embodiment, when the SLA enforcement module 312 cannot meet the consistency requirement for the workload fingerprint of a virtual machine 108, the SLA enforcement module 312 throttles the I/O of applications on SDSs that have lower service level demands, and thus, lower consistency requirements. In addition, the SLA enforcement module 312 also enforces the ceiling and floor values of a range of service levels if such a range is used for the for the service levels. A provisioning and planning software module (not shown) that assists the user or that automatically performs provisioning of an application by using a two-part SLA specification, which includes the target value of the SLO metric and the percentage of time, i.e., statistical guarantee that the SLO must be met, may be employed. The provisioning system therefore determines which SDS 100 is the best fit for the virtual machine and satisfies the associated SLO service level or specification.

By characterizing the virtual machine workload, the implicit I/O performance needs of the virtual machine can be modeled. The I/O performance model can then be used to set an SLO. In addition, the level of guarantee of meeting the SLO or the percentage SLO consistency can be used to specify the SLA. For example, an SLA can state 95% or 75% consistency on the SLO which means that the SLO is met over 95% or 75% of the monitoring period. The above-described two-part SLA, i.e., the percentage guarantee and the SLO, enables the simple combination of business criticality and business priority with application I/O requirements. An implication of this SLO definition is that the target SLO level is based on meeting intrinsic resource needs of the application workload and not on relative priorities with respect to other applications or fairness across the applications that share the same resources. As described above, the goal is to guarantee SLAs of the virtual machines by allocating resources as needed, and not achieve fairness in sharing resources across virtual machines. Additionally, the relative priority is based on the percentage of time the SLO has to be met which is tied to the workloads need and not arbitrary relative sharing of resources. This provides a deterministic method to meet SLAs for the application and not best efforts that relies on fair sharing of the resources.

The above-described determinations take into account the SLOs of other applications already provisioned onto an SDS 100, and the amount of storage performance capacity that is required to meet all of the application SLO requirements. These determinations may also allow users to do “what-if modeling” to determine which service levels to assign to new applications. The present embodiment may also have a storage utilization module that provides recommendations for maximizing efficiency of an underlying SDS after ensuring that SLOs of the applications on the same SDS are met.

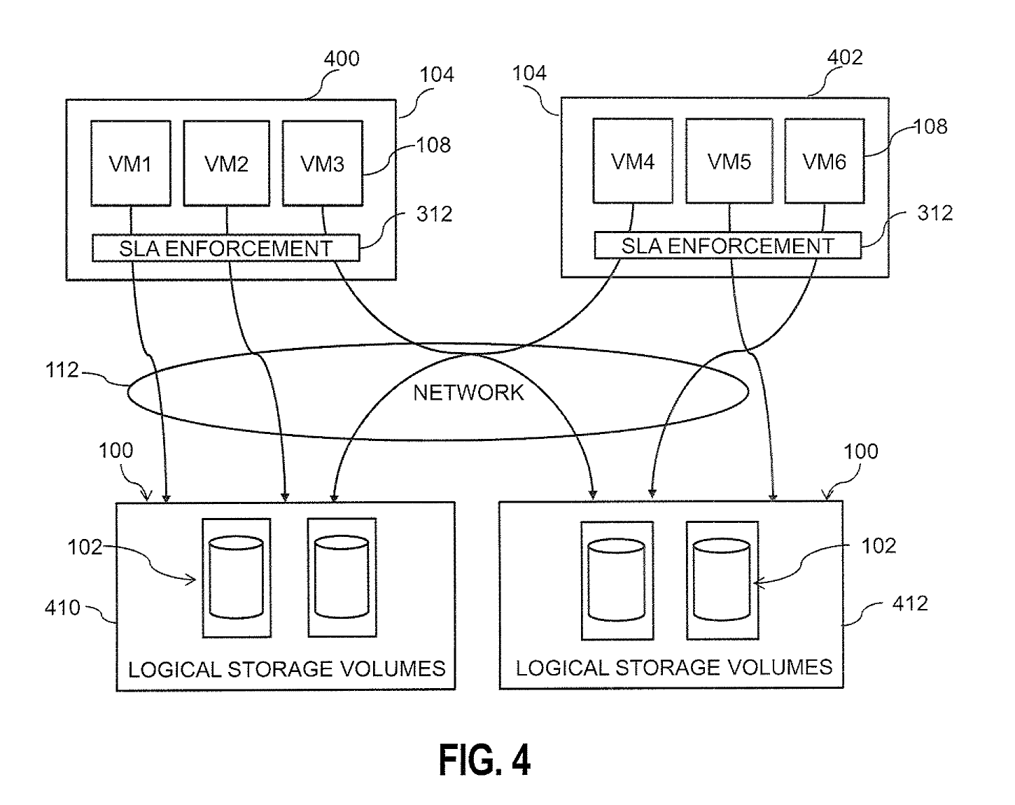

FIG. 4 is a diagram showing SLA monitoring and enforcement being performed at the VM host 104. In this embodiment, the SLA enforcement module 312 is located within the VM host 104, and ensures that issued IOs are controlled to a level such that SLAs of the virtual machines 108 are met. This approach may require controlling the rate at which I/Os from the virtual machines 108 within the VM host 104 are allowed to exit the VM host 104 to the target storage LSV 102 in the SDS 100. The embodiment of FIG. 4 includes two VM hosts, referred to individually as a first VM host 400 and a second VM host 402 that are connectable to a first SDS 410 and a second SDS 402. The first VM host 400 includes three virtual machines VM1, VM2, and VM3. The second VM host includes three virtual machines VM4, VM5, and VM 6. To ensure SLAs are satisfied in all the virtual machines 108 in all the VM hosts 104 requires communications between the SLA enforcement modules 312 of all the VM hosts 104.

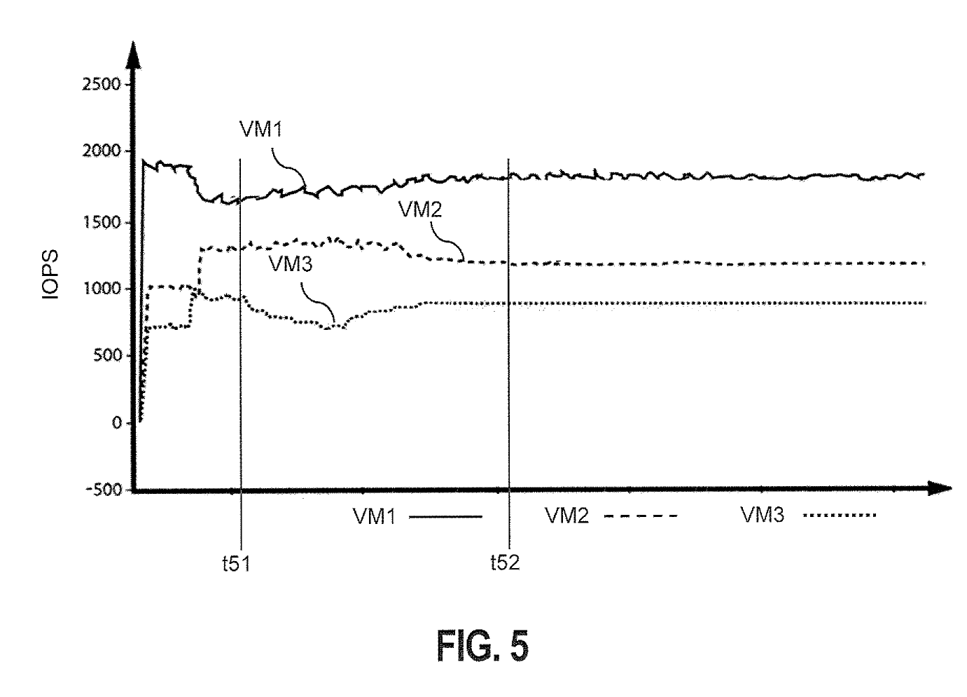

FIG. 5 is a graph showing the results of using the SLA enforcement module 312 within the first VM host 400 of FIG. 4. In this embodiment, VM1 is the virtual machine with the highest SLA service level, VM2 is a virtual machine that has an intermediate SLA service level and VM3 has the lowest SLA service level. The SLO associated with the SLA is I/Os/per second or IOPs. When the flow of VM2 increases because of increases in its workload, it causes the IOPs of VM1 and VM3 to drop below their specified SLA as shown at time t51. Subsequently the SLA enforcement module 312 reduces the rate at which VM2 I/O requests are allowed to leave the VM host 400. As a result, by time t52, the IOPs of VM2 have been reduced and the IOPs of VM1 and VM3 have been restored to their desired SLA levels

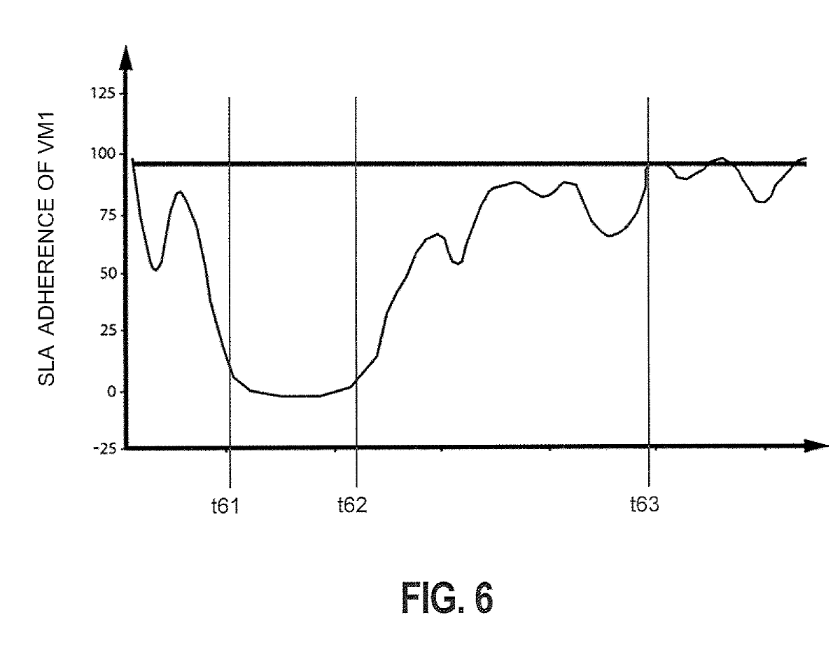

FIG. 6 is a graph showing how closed loop control in the network improves SLA adherence in percentage terms for VM1. As in the example of FIG. 5, at time t61 the increased I/O levels associated with VM2 causes VM1 to miss its SLA and its SLA adherence drops to below 25%. After SLA enforcement is initiated at time t62, the SLA associated with VM1 recovers and is at nearly 100% adherence by time t63.

One embodiment of SLA enforcement addresses conditions set forth below in providing SLA based guarantees of I/O performance for physical or virtual machines 108 located on SDSs 100. As described above, SLAs based on I/O performance may be specified by implicit measurements and do not need explicit performance measurements, which addresses workloads that are latency and/or bandwidth sensitive. Enforcement of different SLAs for different virtual machines sharing LSVs on SDSs are necessary when different virtual machines are provided with different SLAs and levels of guarantee, and when the workloads are dynamic. The SLA enforcement provides the option of coarse-grained enforcement using rate based I/O traffic shaping and fine-grained enforcement using deadline based scheduling at the storage I/O level. Traffic shaping is rate-based control like a token bucket approach, where the I/O requests from n virtual machines are forced to a certain rate after buffering, even if the arriving requests are not periodic. The two approaches in sequence are rate shaping of the I/O requests and scheduling of arrived traffic from different flows based on their deadlines, such as earliest deadline first.

The examples described herein include situations where the enforcement is enabled at the network 112, FIG. 1, or SDS 100 when the knowledge of the flow and its SLA can be provided centrally to the network 112 or the SDSs 100. Enforcement can also be performed at the VM host 104 and all the I/Os from the virtual machines 108 can be controlled at an I/O port (not shown) emanating at the VM host 104 as was shown in FIG. 5 and FIG. 6. Alternatively, the enforcement may be at an LSV 102 on an SDS 100.

Module 306 in FIG. 3 includes estimating the storage performance characteristics of available SDSs 100. With the I/O performance measurement performed on a flow by flow basis, the ongoing and maximum performance capacity of the SDS that is shared across multiple flows can be estimated. Examples of data collected for estimating performance of SDSs 100 are provided as follows. The sum of all average I/O throughput (IOPs) read and the average IOPs written for all flows over a previous interval may be measured. The sum of all average IOPs read and the average IOPs written for all flows active over a previous interval may be measured. The maximum service time or latency observed over an interval across all flows on the SDS may be measured. The sum of IOPs, the sum of data transferred, and the maximum service time may be measured as 3-tuple for the previous interval. This 3-tuple is recorded for every interval suggested above. This metric is derived and may be maintained separate from the workload attribute for estimating performance capacity of all SDSs.

Another measurement of storage performance is the estimated maximum performance of each SDS 100. This can be achieved by injecting synthetic I/O loads into SDSs 100 during idle times. Additionally, the peak IOPs can be estimated from the inverse of an LQ slope, wherein L is the measured I/O latency and Q is the number of outstanding I/O commands. Thus, knowing the maximum performance capacity of the SDS 100 and the current I/O capacity in use provides the available performance capacity at any time.

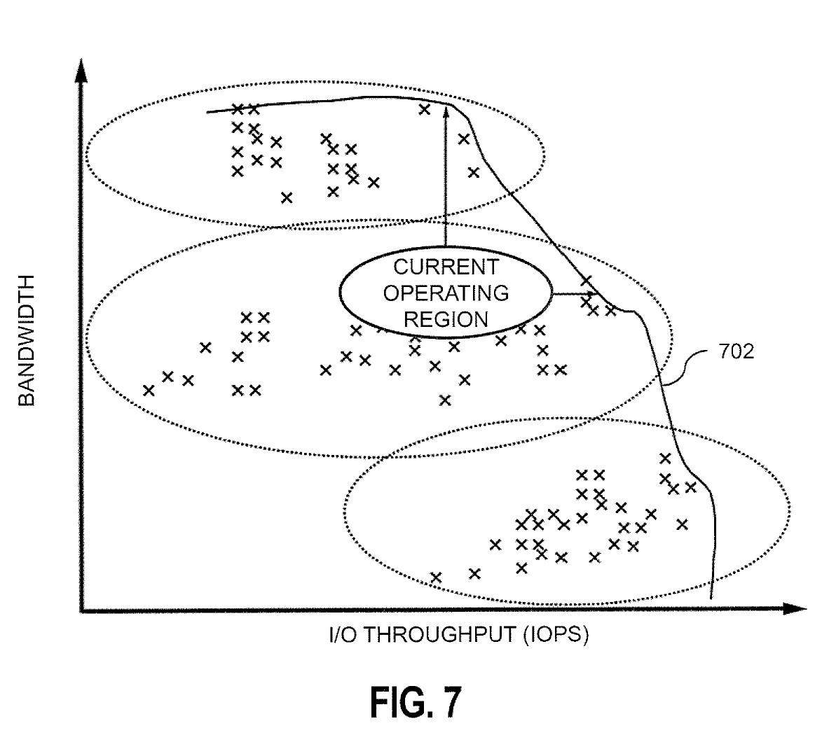

FIG. 7 is a is a graph showing a method for estimating available or residual I/O performance capacity or storage performance capacity, which may be in terms of estimating a combination of available bandwidth IOPs. One example of modeling residual I/O performance capacity is to build the expected performance region across two dimensions, such as bandwidth and I/O throughput as shown in FIG. 7. As the SDS 100 is monitored over different loads, including synthetic workloads to force the system to its maximum performance limits, the expected performance envelope that provides the maximum combination of bandwidth and throughput possible as shown by the line 702 in FIG. 7 is generated. Therefore, at any time, the current operating region can be assessed and the maximum throughput or bandwidth that can be expected can be specified as a pair of values or a 2-tuple. This 2-tuple represents the maximum residual bandwidth or I/O throughput that is available for any new application that can be provisioned. The maximum performance capacity of the SDS 100 is known, and as more and more virtual machines 108 are provisioned, the amount of residual performance that is available is maintained, thereby providing the criterion as to whether more virtual machines 108 can be provisioned on the same SDS 100.

SLA enforcement is dependent on fingerprinting or characterizing the workload of a virtual machine, which may be achieved with token bucket models. Token bucket models are well-suited for applications where the I/O workload does not include many bursts and the workload can be adequately modeled using token bucket parameters, such as rate and maximum burst size. I/O measurements that characterize the virtual machine workload by monitoring flow and workload modules include several parameters. One parameter is the I/O size, which is the size of the I/Os and may be captured during each measurement interval, which may be a multiple of the shortest inter-arrival time of I/O requests. Another parameter is the nature of a SCSI command, such as whether it is a read or write command, or neither. The nature of the SCSI command is captured in the measurement interval and may be aggregated after every measurement interval for the I/O bucket size.

In addition to the workload characterization metrics described above, other statistical attributes may also be measured. One of these attributes is I/O size distribution, wherein the I/O size data is captured by the module 308, FIG. 3, and may be bucketized into the several sizes. Examples sizes include: a small size of 4 KB or less; a first medium size of 4 KB to 16 KB; a second medium size of 16 KB to 63 KB; a first large size of 63 KB to 255 KB; a second large size of 255 KB to 1023 KB; and a third large size that is greater than 1023 KB.

One of the other attributes is the average I/O size, which is based on the previous measurement and/or aggregate period. An attribute related to the maximum I/O size is based on the maximum I/O size for the previous measurement and/or aggregate period. Similarly, an attribute related to the minimum I/O size is related to the previous measurement and/or aggregate period. An attribute related to read/write distribution is based on the percent of the I/Os that are read or written and may be maintained for every I/O bucket size described above. A sequential random distribution attribute is based on the percent of random or sequential I/Os. A non-read/write attribute is based on the percent of I/Os that are not read or written.

Estimating the I/O performance for a virtual machine involves continuous measurements of different metrics that may be captured. A service time metric may be measured in real time by the I/O monitoring module 304, FIG. 3, which is operable to provide information regarding the time to perform certain functions. An average service time metric provides the average time to complete I/O request on an LSV 102 and may be sampled over a plurality of I/Os, such as the previous 100 I/Os or 1000 I/Os. The number of I/Os on which the average service period is measured may be based on experimentation and testing of deadline based scheduling. For example, the minimum averaging period could be 1,000 I/Os. A maximum service time metric may be measured by the time the target LSV takes to complete I/O requests made by the virtual machine. A minimum service time metric may be measured and is related to the minimum time to complete I/O requests on an LSV. A metric related to the number of I/Os submitted may be measured and may be based on a small multiple of the intrinsic period of the application when it is known during SLA enforcement and for every measurement interval. This metric is also required to calculate the I/O completion rate or a contention indicator ratio. The number of completed I/Os is a metric that may be measured over a predetermined interval and is used to calculate the contention indicator ratio. A metric related to the number of data read commands transmitted during measurement interval may be measured. Likewise, a metric related to the number of data write commands transmitted during a measurement interval may be measured.

Other metrics may be measured, such as a cache hit as described above, which is determined by observing service times for equally-sized commands. In the embodiments described herein, the cache hit metric is tracked in real-time. In some examples, cache hit is measured for small sized to medium sized reads commands. To simplify tracking in real time, the I/O monitoring entity may compare I/O service time for every I/O and check it against a minimum service time. If the I/O is determined to be a cache hit, it is tagged as such, so the I/O monitoring module flags cache hits on a per I/O basis.

In addition to the I/O performance service level metrics described above, other performance metrics can also be measured and derived. The maximum observed data or bandwidth for read or write commands may be measured. This metric may be based on the total data read during any I/O command. The average observed data related to read commands may also be measured. In addition, the maximum observed data for write commands may be measured, which is the total data written during any I/O command. The average observed data for write commands may also be measured. The maximum observed IOPs and average IOPs for read and write commands may be measured during an I/O operation.

Several metrics related to submission and completion rates may be measured. An I/O submission rate metric, which is a running rate of the number of I/Os submitted to an SDS over a predetermined number of time intervals, by may be measured. In some examples, the measurement is made over a number of intervals “M” wherein each interval has an interval time tau. In one embodiment, the number of intervals M is 3 and tau is less than 500 ms. The maximum I/O submission rate may be measured, which is based on the maximum rate of I/O commands submitted over M intervals. Maximum and average I/O completion rates may also be measured, which may be based on the number of I/Os completed by the SDS. It is noted that when the ratio of the average I/O completion rate to the average I/O submission rate drops below one, it is an indication that the SDS is in contention and possibly in a region of less than maximum performance.

An SDS is in performance contention if it drops below its running average by a predetermined amount. For example, the SDS may be in performance contention if it is operating 20% below the normal running average as determined by a contention indication average. As described above, contention may be determined when the ratio of the I/O completion rate to the I/O submission rate or falls below 1. Since the ratio may show large variance with traffic bursts, the performance contention may be determined during an interval

In some embodiments, a moving window of size M*tau is implemented to measure the above-described metrics. For example, an I/O monitoring module may maintain two counters that measure the number of I/Os submitted and the number of I/Os completed. These counters accumulate their respective metrics that are captured by the I/O monitoring module. In some examples, the value of M is kept small to avoid missing sudden changes in either metric.

It is noted that when the average I/O completion rate and average I/O submission rate are used as indicators of a performance capacity region, queue depths are not used. However, observing the maximum queue depth and the average service time may provide indications of the SDS operating at its maximum performance capacity. For example, if the rate of increase of the average service time is higher than the rate of increase in the queue depth, then it is also an indication that the SDS is operating at its maximum performance capacity.

Most of the derived performance metrics may be computed in a batch mode. The number of I/Os completed and the number of I/Os submitted along with determinations as to whether the SDS is operating in contention are typically monitored in real time to determine if performance capacity is being reached.

A method of enforcing SLAs per workload is described below. The method commences with initial monitoring or logging I/O data to capture each I/O of the workload. In addition, the monitoring may estimate observed performance capacity in terms of latency, IOPs, and bandwidth. The period for monitoring data may be over days or weeks depending on the periodicity of the workload. An implicit model is then built and the shared data storage performance capacity is estimated based in the initial monitoring of the I/O data.

SLA enforcement targets are derived based on the observed storage performance when the normal application workload is executed. Thus, if the I/O arrival rate generated by the application is not throttled or controlled, then the rate of I/O completion or throughput, as one performance metric, provides the expected SLO for I/O throughput. This maximum value of the I/O throughput corresponds to the 100% value of the SLO. To model the expected workload of the application, the following parameters are used: a time interval (tau) during which I/O arrivals are measured, the maximum arrival rate, and an associated burst that is allowed during every interval are derived using one of many known approaches known for token bucket modeling. Furthermore, the percentage of I/Os for each workload that is to be allowed to go to the SDS based on the service levels is specified by the SLA. This percentage corresponds to the consistency level of the SLA, where 100% SLA consistency means all I/O requests are accepted and 50% consistency SLA means only half the I/Os are accepted.

Token bucket filters per SLA target are enforced for every flow per SDS to ensure that the workload is constrained to specific I/O arrival rate or a maximum burst. The level of tolerance for meeting an I/O performance requirement is dictated by the SLA consistency. For example, an SLA that specifies 95% consistency means that the error between observed performance and target performance should be only 5% during the monitoring period.

Workload I/O parameters may be monitored to observe metrics of the workload, such as I/O size, arrival rate, etc., as well as the performance parameters such as latency, completion times, etc. Metrics are maintained so that any changes in the workload over time and changes in the applications are captured. As workloads change, new token bucket parameters, i.e., arrival rate and burst rate are then derived using the measured metrics. The new token bucket parameters are used to enforce the SLA consistency level. Thus, if the workload changes such that the arrival rate increases by 10%, then per the SLA, 10% more I/O arrivals will have to be accepted by the SDS. In addition to I/O arrival information, other flow-related information may also be collected for each flow, such as service times and I/O size.

For more latency sensitive applications, deadline based scheduling or earliest deadline first (EDF) may be used based on the additional flow information. In some situations where worst case I/O completion times or deadlines are known, EDF scheduling can be applied either at the VM host or in a network switch or storage. This approach is based on extensions that are used for providing fine-grained SLAs, such as scheduling I/O requests to ensure that latency SLO requirements on individual I/O operations are met.

During an initial monitoring period of applications, information related to storage I/O service times is gathered for various applications from which the I/O deadline requirements are derived. The system schedules I/Os to the SDS, such that I/Os with the earliest deadlines complete first. I/Os in an EDF scheduler are grouped into a plurality of buckets, such as three buckets. For example, I/Os are fed into the EDF scheduler either from a rate based scheduler or directly. Each incoming I/O is tagged with a deadline and gets inserted into an EDF queue, which is sorted based on the I/O deadlines. An SLA enforcement batch may include a batch of I/Os waiting to be submitted to the SDS. Irrespective of the order in which the I/Os in the batch are completed by the SDS, the earliest deadline requirement is met. A storage batch includes a batch of I/Os that are currently being processed by the SDS. An EDF scheduler keeps track of the earliest deadline amongst the I/Os in the SDS and computes slack time, which is the difference between earliest detection and the expected completion time of I/Os in the storage batch.

Computing the expected completion time of all the I/Os in the storage-batch involves adding the service times of I/Os to produce a conservative estimate. An I/O control engine continuously monitors the ongoing performance of the SDS by keeping track of I/O service times as well as the throughput rate R at which I/Os are being completed by the SDS. The expected completion time of I/Os in the storage batch is computed as N/R, where N is the number of I/Os in the storage batch and R is rate at which IOs are being completed. Slack time is used to determine the set of I/Os that can move from the EDF queue to the SLA enforcement batch, which is the next batch of I/Os to be submitted to the SDS.

Monitored data may used as an input for EDF. For example, average I/O service time or the I/O completion time for any I/O on a SDS may be represented as a sparse table. The sparse table keeps the mapping function for an I/O as the average service time, which is a function of the I/O size, and other factors such as whether the I/O is sequential or random, and whether it is a read or a write. This information is maintained in addition to the most recent observed I/O completion time, which can vary.

Workload intensity is a measurement that can be used to determine SLA compliance and is the I/O submission rate divided by the I/O completion rate. The I/O submission rate is the current rate of I/Os submitted to a disk target and the I/O completion rate is the current rate of I/Os completed by the disk target. The I/O submission rate may be less than the I/O completion rate. Once the target storage is in contention, increasing the I/O submission rate does not result in increasing I/O completion rate. More specifically, once workload intensity is greater than or equal to one, the target storage is saturated, and the average service time should be expected to increase non-linearly. The cache hit rate for a given workload is estimated by observing the completion times of I/Os for the workload. Whenever, a random I/O completes less than typical disk times, then it is expected to be from a cache hit, otherwise it is from a disk. If the cache hit rate is consistent, it can be used to get better weighted estimate of the I/O service time.

Control parameters for the EDF are described below. A number N is the number of frame storage batches of duration tau, which is dictated by the average arrival rate of I/Os for the workload and is the same as used in the token bucket model to enforce traffic shaping. The above parameters determine the number of I/Os, or the size of the window over which reordering is done to meet all deadlines. There is a tradeoff between meeting deadlines and utilization of the target storage, which is the number of storage batches N. A high value of N is indicative of a large ordering set that squeezes in many I/Os in every storage batch and is optimized for the highest utilization. However, a large ordered set results in high latency, which can result in missing some I/O deadlines.

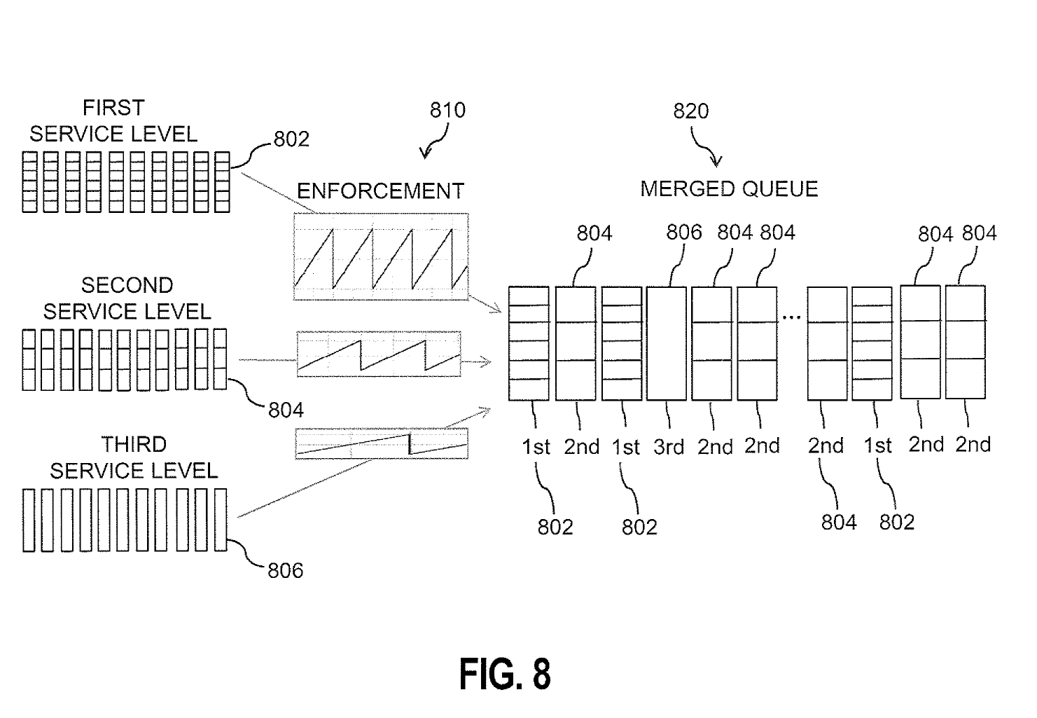

A scheduling approach for SLA enforcement will now be described. Reference is made to FIG. 8, which shows I/O combinations for different service levels of virtual machines 108 in FIG. 1. The first service level 802 has the highest priority per its SLA agreement. The second service level 804 has the second highest priority per its SLA agreement and the third service level 806 has the lowest priority level.

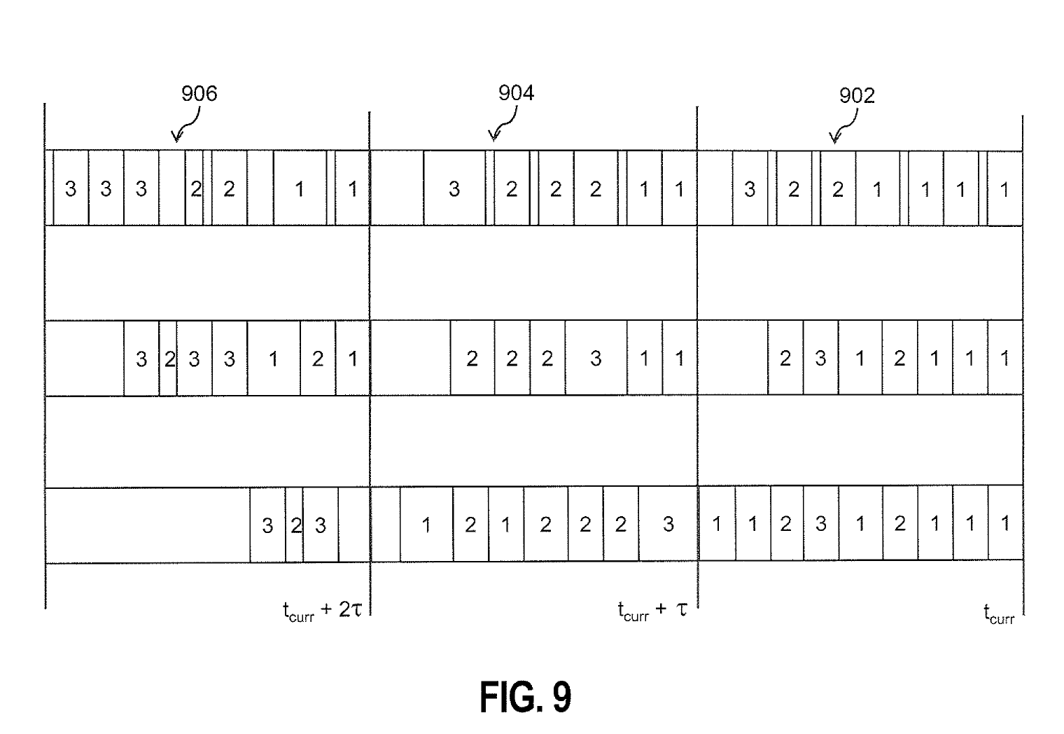

The scheduling approach begins with building an ordered set of scheduling. This ordering is based on the number of I/Os received per time unit tau, which is an enforcing period referred to as a frame, such as t_{curr}, t_{curr} Tau, t_{curr}+2Tau as shown in FIG. 9, which is the sequence of I/Os used for the scheduling. The I/Os are not ordered by deadline, but ordered based on the admission control imposed by the SLA enforcement per the service level using the token bucket traffic shaping described earlier. The ordered set is over N predetermined frames based on a tradeoff between meeting deadline guarantees and utilization of the target SDS. The enforcement column of FIG. 8 shows the number of I/O requests as a function time, which may be tau. A merged queue shows the priority of the queuing. As shown, the first service level 802 occupies most of the queue because of its priority in the SLA. FIG. 9 shows efficient I/O scheduling in a shared storage queue using reordering of I/Os in each frame and using frame packing. Each period of tau is filled with I/Os obtained from the traffic shaping done by the SLA enforcement using a token bucket model. The total number of I/Os of each SLA service level are shown as 1, 2 or 3 for the above-described three SLA levels and are defined by the SLA enforcement policy. For example, for any SLA level, a certain percentage of all arriving traffic in the period tau for SLA service level 1 is admitted to the target storage.

In the example described above, in the first tau frame 902 starting at t=t_{curr}, there are four I/Os from SLA level 1, two I/Os from SLA level 2, and one I/O from SLA level 3. In the second tau frame 904 starting at t=t_{curr}+tau, there are two I/Os from SLA level 1, three I/Os from SLA level 2, and one I/O from SLA level 3. In the third tau frame 906 starting at t=+2tau, there are two I/Os from SLA level 1, two I/Os from SLA level 2, and three I/Os from SLA level 3. The token bucket enforcement may be set by an expected rate of I/O requests, the burst size for each workload and the percentage statistical guarantee of supporting I/Os for that level onto the target disk. In summary, the token bucket shaping provides reserved capacity in terms of I/Os for a specific workload for a specific SLA level.

In some embodiments, referred to as horizon related EDF, the admitted I/Os are ordered per tau for each frame by their deadline EDF. Horizon refers to the largest deadline of the ordered set. The ordered set or the number of I/Os to be considered in the re-ordering queue is all the I/Os in N tau frames. For example for highly latency sensitive application, two frames may be used, but more can be considered. Accordingly, if there are N I/Os in N tau frames, then the horizon is equal to the longest or maximum deadline. Therefore, all scheduled N I/Os in the N tau time period must be completed in a time of (t_{curr}+horizon). The average service may be selected from a service time table built from prior observed I/O completion times.

I/Os are submitted to the SDS 100 from the ordered set as soon as the schedule for submission is completed. It is assumed that the SDS 100 can execute them in any order or concurrently. As described above, with larger values of N, the utilization of the SDS 100 can be increased. As each submitted I/O from the ordered set is completed by the SDS 100, the actual service time is compared against the estimated response time. Since the average response time is based on typical or average execution time, the discrepancy or error is determined as the difference between the average service time and the actual service time. It is expected that the error is positive, thus as I/Os complete, the level is corrected so that the corrected level is less than the difference in the present level and the error. As the level is updated with positive errors, it exposes more slack time since the target storage system is not as busy as had been expected.

Updating the average service time table as a function of workload intensity will now be described. Since the service time is based on loads where the loads are approximated by workload intensity, which is equal or proportional to the ratio of I/O submission rate and I/O completion rate, it is possible to get further granularity in the average service times as a function of workload intensity. The next step involves ordering I/Os in each frame in an ordered set. Once the I/Os of each frame are received, the I/Os are ordered based on the deadline of each I/O. Because the I/Os have been admitted for the frame, the ordering is done based on the deadline of an I/O independent of its SLA service level.

The final step is frame packing, which involves calculating the slack time in each frame for the ordered set. If there is sufficient slack time in a frame, the I/Os with the earliest deadline are moved from the next frame into the current frame. It is assumed that all I/Os complete within a frame based on admission control imposed by token bucket shaping. At this stage, the estimation of the completion time is made using the average service time table for each I/O. If there is slack time, where the slack time is equal to the sum of a plurality of actual service times, then I/Os are moved forward from the next frame. For example, the I/Os from the second tau frame 904 are considered to be scheduled in the slack time of the first tau frame 902. The order of the I/Os to be moved are I/Os with earliest deadline and if there are two I/Os with the same deadline, then the I/O of the higher SLA level is moved first. When moving up I/Os, priority may be given by SLA service level. For example, SLA level 1 I/Os are moved before SLA level 2 I/Os and so on. It is noted that this is done only if there is no ceiling on the SLA level that is moved up to the next frame. At the end of the end of each frame packing step, the best I/O packing per enforcing period or tau within the ordered set is achieved.

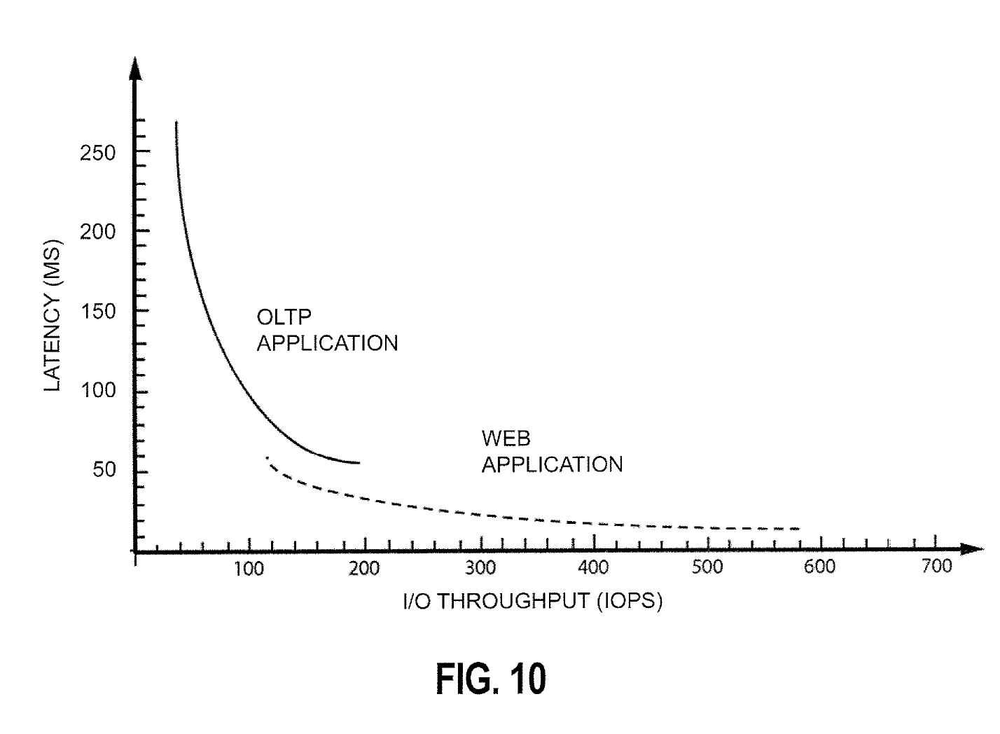

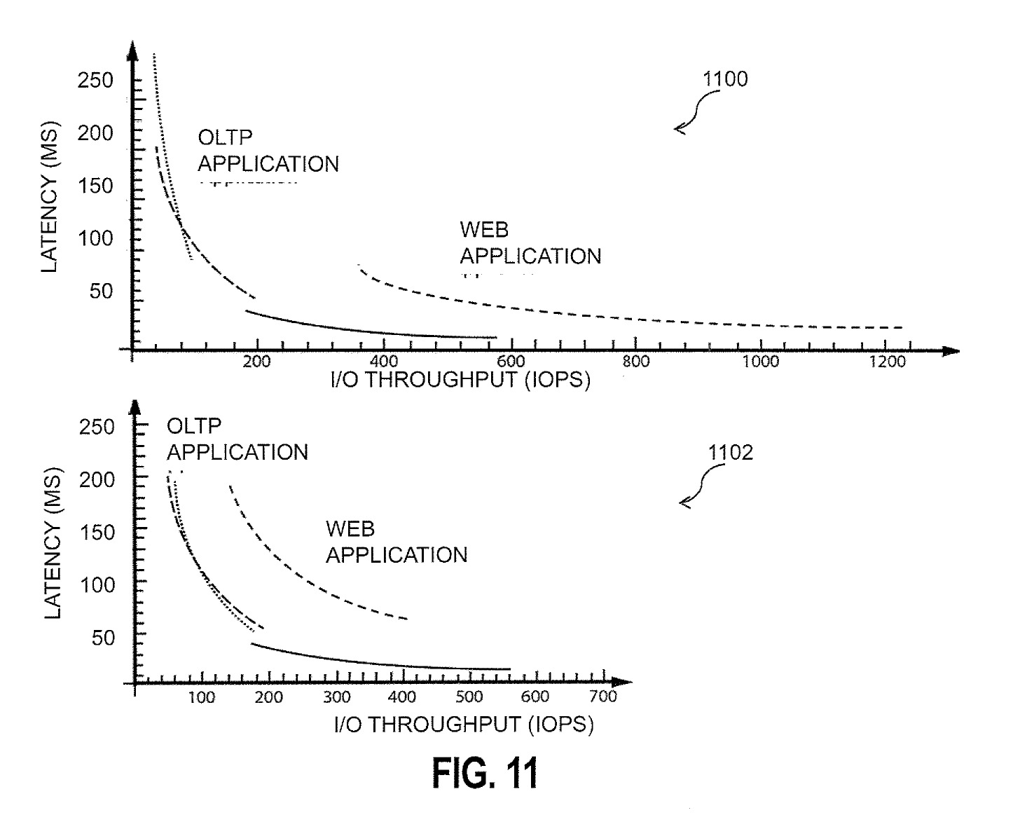

FIGS. 10 and 11 show examples of workloads that share the same storage, with different SLA levels, and SLA enforcement implemented at the VM host 104. The examples use a VM host storage output queue control mechanism of a VM manager. FIG. 10 shows the workload profiles of two virtual machines, an online transaction processing (OLTP) application, and a web application during normal and acceptable performance operating modes. The OLTP application has both read and writes of medium to large I/Os. Its baseline IOPs are in the range of 50 to 200 IOPs with an associated latency of 50 to 250 ms. The web application is a read-only application for small data sizes as expected from a browser application or the like. Its IOPs range is 120 to 600 with an associated latency in the range of 10 to 50 ms. In this example, the OLTP application is identified as the higher SLA application and the web application is identified as the lower SLA application.

The graph 1102 of FIG. 11 shows how the workload profile for both applications changes when the web application increases its workload to more than twice its baseline IOPs. The result of this increased workload results in the web application increasing its I/O rate by 100%, from a range of 120-600 IOPs to a range of 380-1220 IOPs with modest increase in latency. The impact of the increased I/Os in the web application causes the OLTP application to drop well below 100 IOPs and latency to deteriorate from the 50 to 250 ms range to the 100 to 290 ms range. This change is the result of the smaller more frequent reads from the same SDS, which causes increases the read and write operations to be delayed.

The graph 1102 of FIG. 11 shows how closed loop control in the VM host, using control mechanisms to reallocate shares in the output queue of the VM host, is used to enforce SLAs on both applications. Closed loop control ensures that the OLTP application is brought back to the original IOPs and latency range. This is achieved at the expense of the web application, which had a lower SLA requirement, so its greater number of I/Os experience higher latencies and lower IOPs.

Reference is made to FIG. 3, to show that utilization of storage resources for all virtual machines may require the steps described below. Flow and workload are monitored and performance is captured. Other service levels and associated resource usage per virtual machine, LSV, and the underlying SDS 100 are also monitored and captured. If SLAs are not being met by a virtual machine, the SLAs are enforced. If SLAs of a virtual machine are not being met by the current LSV, then re-provisioning, including modification or migration, may be performed.

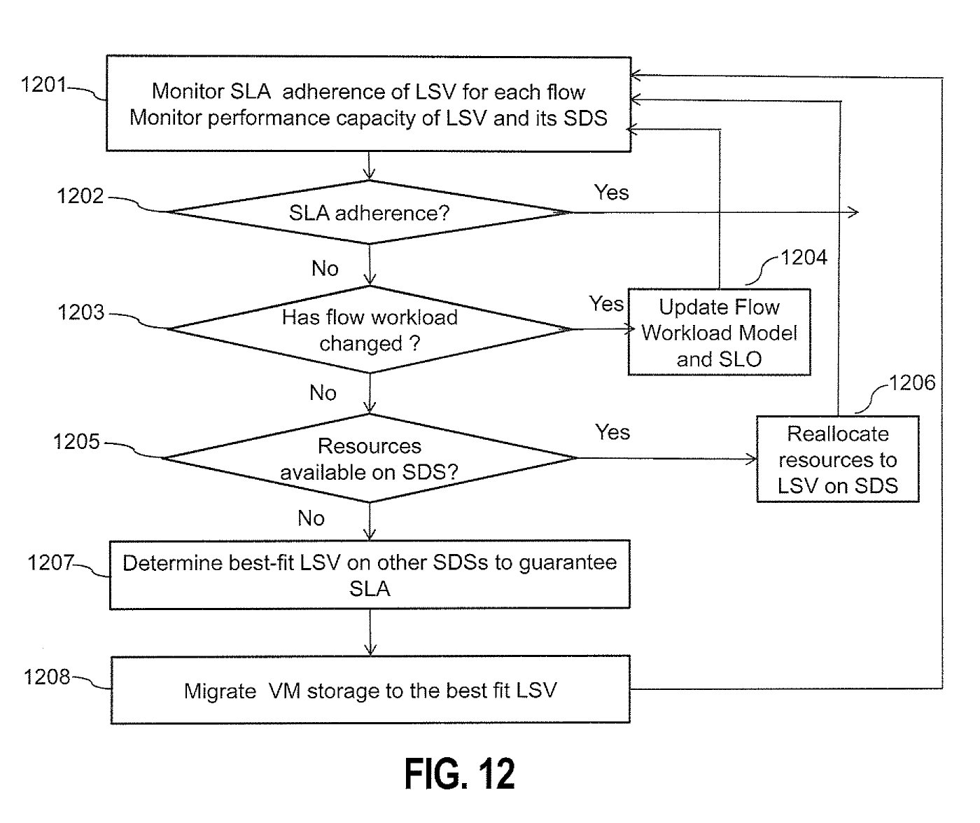

FIG. 12 is a flowchart describing an embodiment of the dynamic provisioning process at the virtual machine level. As new virtual machines are added or removed or as their workload changes, the storage performance needs of the earlier provisioned LSVs changes. This creates the need for reprovisioning LSVs on an ongoing basis, or the need for dynamic provisioning of LSVs for all active flows. Dynamic provisioning is initiated when the storage management 110, FIG. 1, detects that SLA adherence for a flow has failed. As described in FIG. 3, the workload of each flow and the performance of the LSV and associated SDS is monitored by module 304. Further, if module 312 is not successful in enforcing SLA enforcement, then it would be detected as well. Some causes of SLA enforcement failure include concurrent increases in the workloads of the flows that share LSVs on the same SDS or a failure the SDS that reduces its total performance capacity.

For every flow, the SLA adherence of an LSV and the underlying performance capacity of the SDS are monitored continuously in step 1201. If SLA enforcement module 312 is not successful in enforcing SLAs for the flow, then it is detected at step 1202. If SLA adherence is not met, then processing proceeds to step 1203 where module 308 determines if the workload model of the flow has changed. If the workload model has changed, then the model is updated, for example, by updating the token bucket parameters as described earlier, as well as the SLO for the SLA based on the new workload model in step 1204.

If the workload model has not changed, then processing proceeds to step 1205 wherein the storage management 110 determines whether there are adequate resources or residual performance capacity in the underlying SDS to meet the SLA. If the performance capacity of the SDS has not been exceeded, then more resources are added to the LSV to meet the SLA for the flow in step 1206. Such resource reallocation could include increasing the buffer capacity for the flow in the I/O queue of the SDS. In some embodiments, the resource reallocation can only be possible if there is enough storage performance capacity to meet the SLAs of the flows that have their LSVs on the SDS.

If the current SDS does not have additional storage performance capacity, then the storage management 110 searches among available SDSs and determines the best-fit LSV that would meet the SLA in step 1207. A number of methods can be implemented to determine the best fit LSV from among available LSVs on the SDSs that have performance capacity. These methods include a variation of well-known greedy algorithm where the SDS with most performance capacity is chosen for the desired LSV. Other algorithms with different criteria can also be implemented. Once the new LSV has been chosen for the flow, then the existing data on the current LSV is migrated to the new LSV in step 1208 while ensuring that the ongoing I/Os from the flow are redirected to the new LSV.

The methods and systems described herein implement an SLA-based provisioning of storage for virtualized applications or virtual machines on shared data storage systems. The shared data storage systems can be located behind a network or on a virtual distributed storage system that aggregates storage across direct attached storage in a server, a VM host, behind the storage area network, or in a local or wide area network.

An approach that can be used to set SLAs on performance for applications on shared storage has been described above. One embodiment includes: defining SLAs; characterizing application I/O workloads; estimating performance capacity of shared I/O and storage resources; enforcing SLAs of applications; and provision applications as their workload change or new applications are added.

1. A method for provisioning storage for virtual machines by meeting a service level agreement (SLA), wherein the SLA pertains to the operation of a first virtual machine, the method comprising:
monitoring the workload of the first virtual machine;
establishing at least one service level objective (SLO) in response to the workload;
determining an SLA that meets the at least one SLO, wherein the SLA defines the time the SLO is satisfied; and
provisioning at least one resource used by the first virtual machine in response to the SLA not being satisfied, wherein the provisioning causes the SLA to be satisfied.

2. The method of claim 1, wherein the at least one SLO includes latency.

3. The method of claim 1, wherein the at least one SLO includes bandwidth.

4. The method of claim 1, wherein the at least one SLO includes throughput rate of I/Os.

5. The method of claim 1, further comprising adding a second virtual machine in response to the at least one SLA of the first virtual machine being satisfied and addition of the second virtual machine does not result in the SLA of the first virtual machine not being satisfied.

6. The method of claim 5, wherein the second virtual machine has at least one second SLO associated therewith and wherein adding the second virtual machine is further in response to the at least one second SLO being satisfied.

7. The method of claim 5 further comprising removing the second virtual machine in response to the at least one SLA of the first virtual machine not being satisfied.

8. The method of claim 1 further comprising not admitting a second virtual machine in response to the at least one SLA of the first virtual machine not being satisfied.

9. The method of claim 1, wherein the provisioning includes moving a logical storage volume associated with the first virtual machine.

10. A method for provisioning resources available to virtual machines, the method comprising:
monitoring the workload of a first virtual machine;
establishing a first service level objective (SLO) in response to the workload of the first virtual machine;
determining a first SLA that meets the first SLO, wherein the first SLA defines the time the first SLO is satisfied;
monitoring the workload of a second virtual machine;
establishing a second service level objective (SLO) in response to the workload of the second virtual machine;
determining a second SLA that meets the second SLO, wherein the second SLA defines the time the second SLO is satisfied; and
provisioning at least one resource used by the first virtual machine in response to the first SLA not being satisfied, wherein the provisioning causes the first SLA to be satisfied.

11. The method of claim 10, wherein the provisioning includes reducing at least one resource used by the second virtual machine.

12. The method of claim 10, wherein the provisioning includes removing the second virtual machine.

13. The method of claim 10, wherein the provisioning includes moving a logical storage volume associated with the first virtual machine.

14. The method of claim 10, wherein the first SLO and the second SLO include latency.

15. The method of claim 10, wherein the first SLO and the second SLO include bandwidth.

16. The method of claim 10, wherein the first SLO and the second SLO include throughput rate of I/Os.

17. The method of claim 10, wherein the first SLO and the second SLO include storage capacity.

18. The method of claim 10, further comprising adding a third virtual machine in response to the first SLA and the second SLA being satisfied.

19. A method for dynamic provisioning of storage for virtual machines, the method comprising:
running a first virtual machine on a shared data storage;
identifying at least one storage requirement for the first virtual machine; and
adding a second virtual machine on the shared data storage when the at least one storage requirement for the first virtual machine has been satisfied and resources used by the first virtual machine accommodates a resource requirement for the second virtual machine.

20. The method of claim 19 comprising reducing shared data storage available to the second virtual machine in response to the at least one storage requirement for the first virtual machine not being satisfied.
